(19) United States
(12) Patent Application Publication
(10) Pub. No.: US 2007/0197299 A1
(43) Pub. Date: Aug. 23, 2007

(54) Secure Gaming Chip

(75) Inventors: Ronald N. Miller, Toronto, ON (CA); Christian Richard, Dorval, QC (CA)

Correspondence Address: BOND, SCHOENECK & KING, PLLC, 10 BROWN ROAD, SUITE 201, ITHACA, NY, 14850-1248, US

(73) Assignee: UBI-TRAK, Montreal (CA)

(21) Appl. No.: 11/463,720

(22) Filed: Aug. 10, 2006

Related U.S. Application Data
(60) Provisional application No. 60/773,103, filed on Feb. 14, 2006.

(51) Int. Cl. A63F 13/00

(52) U.S. Cl. 463/43

(57) ABSTRACT

The present invention is directed to an article of manufacture that includes an RFID inlay having a programmable integrated circuit coupled to a propagation element on a first side of a rigid two-sided printed circuit board. The programmable integrated circuit is covered by a protective material having at least one material characteristic, whereby the programmable integrated circuit is hardened to withstand a predetermined applied pressure and a predetermined ambient temperature. At least one molded exterior portion encapsulates the RFID inlay. The at least one molded exterior portion is formed by an injection molding process characterized by a molding pressure that is lower than the predetermined applied pressure and a molding temperature lower than the predetermined ambient pressure, whereby the RFID inlay is not accessible without destroying the article of manufacture.

### CROSS-REFERENCE TO RELATED APPLICATIONS

The present invention is related to U.S. Provisional Patent Application Ser. No. 60/773,103 filed on Feb. 14, 2006, the content of which is relied upon and incorporated herein by reference in its entirety, and the benefit of priority under 35 U.S.C. §119(e) is hereby claimed.

### BACKGROUND OF THE INVENTION

1. Field of the Invention

The present invention relates generally to gaming, and particularly to a secure gaming chip for use in casinos and/or other gaming establishments.

2. Technical Background

Gaming chips, or poker chips as they are often referred to, are used by casinos and other such gambling establishments as a form of currency. Before playing poker, baccarat, craps and/or other games of chance, a person, i.e., the “player,” will typically go to the table game and buy gaming chips from the dealer. When the player is finished, he will take the gaming chips in his possession to a cashier and exchange them for cash. Because a gaming chip is a form of currency within the grounds of the casino, the threat of fraud and/or counterfeiting is ever-present and a potential cause of concern for casinos and gaming establishments.

One relatively simple way of defrauding a casino is by introducing and using counterfeit gaming chips. The use of counterfeit gaming chips may be perpetrated by a player that is acting alone or in collusion with a dealer. Gaming establishments devote a considerable amount of time and resources toward the detection and prevention of counterfeiting and fraud. Accordingly, a gaming chip that is secure, easily detected and easily trackable is desirable.

In one approach, indicia representing the identity of the gaming establishment is disposed on each of the gaming chips in circulation within the establishment. Certain Mediterranean casinos designed very sophisticated graphic plaques and developed game management rules to improve security. Unfortunately, these efforts were largely unsuccessful because counterfeiters were able to copy the sophisticated designs. The use of Ultraviolet (UV) indicia was also considered as a means to solve the counterfeiting problem. However, the aforementioned security measures cannot fully protect the gaming industry from theft, counterfeiting and/or collusion because indicia printed directly on the chip, and/or printed stickers applied to a chip are easily counterfeited.

In yet another approach that has been considered, some have proposed using a gaming chip having an RFID disposed therein. One benefit of RFID technology is that it provides the casino with the means for automatically detecting and tracking the gaming chips. For example, an RFID inlay may be disposed in a hollow gaming chip, The inlay may be concealed within the hollow cavity by placing a sticker over the inlay. One drawback associated with this approach relates to the fact that the sticker may be easily removed to provide access to the RFID. Once the sticker is removed, the RFID from a genuine casino chip may be replaced by a counterfeit RFID to increase its value and defraud the casino.

In an alternative approach, the RFID may be covered by a plastic cover member or disposed in a plastic insert. However, while the plastic cover member is more tamper resistant than the sticker, it does not obviate the above described security threat.

Unsuccessful attempts have also been made to encapsulate an RFID inlay within a gaming chip by way of injection molding techniques. However, these attempts have been unsuccessful because the temperatures and pressures applied to the RFID during the injection molding process cause the RFID inlay to become damaged and inoperative. RFID inlays are typically fabricated using flexible substrate materials, such as polyester film, which tend to melt, deform, or even vaporize during the injection molding process. Accordingly, what is needed is a method for safely encapsulating the RFID inlay within the gaming chip.

While physical chip security is a very important concern, there is an encryption aspect to chip security that also must be addressed. Conventional RFID gaming chips include read only data, i.e., identification data and chip monetary value, programmed into memory. The movement of the chip is then tracked by electronically identifying the gaming chip at various stations disposed throughout the casino. However, there are drawbacks associated with this approach as well.

For example, a device called a “sniffer” may be employed to intercept transmissions to and from the chip. The intercepted data are then subsequently programmed into the memories of counterfeit chips. Alternatively, a player may take a purchased chip off-premises to read the contents using a commercially available reading device. Thus, even if an RFID is securely embedded in a casino chip, the chip is still susceptible to hacking.

What is needed is an RFID gaming chip that addresses the drawbacks associated with conventional gaming chips. In particular, a gaming chip is needed that successfully encapsulates an RFID inlay within an injection molded chip while, at the same time, is relatively impervious to modern hacking techniques.

### SUMMARY OF THE INVENTION

The present invention addresses the needs described above by providing an RFID gaming chip that addresses the drawbacks associated with conventional gaming chips. The present invention provides a method for encapsulating an RFID inlay within an injection molded chip while, at the same time, is relatively impervious to modern hacking techniques.

One aspect of the present invention is directed to an article of manufacture that includes an RFID inlay having a programmable integrated circuit coupled to a propagation element on a first side of a rigid two-sided printed circuit board. The programmable integrated circuit is covered by a protective material having at least one material characteristic, whereby the programmable integrated circuit is hardened to withstand a predetermined applied pressure and a predetermined ambient temperature. At least one molded exterior portion encapsulates the RFID inlay. The at least one molded exterior portion is formed by an injection molding process characterized by a molding pressure that is lower than the predetermined applied pressure and a molding temperature lower than the predetermined ambient pressure, whereby the RFID inlay is not accessible without destroying the article of manufacture.

In another aspect, the present invention is directed to a secure gaming chip that includes an RFID inlay having a programmable integrated circuit coupled to a propagation element on a first side of a rigid two-sided printed circuit board. The programmable integrated circuit is programmed to include a one-time password. The programmable integrated circuit is also covered by a protective material that has at least one material characteristic, whereby the programmable integrated circuit is hardened to withstand a predetermined applied pressure and a predetermined ambient temperature. At least one molded exterior portion encapsulates the RFID inlay. The at least one molded exterior portion is formed by an injection molding process characterized by a molding pressure that is lower than the predetermined applied pressure and a molding temperature lower than the predetermined ambient pressure, whereby the RFID inlay is not accessible without destroying the gaming chip.

In yet another aspect, the present invention is directed to a secure gaming chip that includes an RFID inlay having a programmable integrated circuit coupled to a propagation element on a first side of a rigid two-sided printed circuit board. The programmable integrated circuit is programmed to include a one-time password. The RFID inlay device also includes a magnetic marker disposed on a second side of the printed circuit board. The magnetic marker is characterized by a unique predetermined magnetic material response waveform. The programmable integrated circuit is covered by a protective material having at least one material characteristic, whereby the programmable integrated circuit is hardened to withstand a predetermined applied pressure and a predetermined ambient temperature. An inner core portion encapsulates the RFID inlay. The inner core portion is formed by an injection molding process characterized by a molding pressure that is lower than the predetermined applied pressure and a molding temperature lower than the predetermined ambient pressure, whereby the RFID inlay is not accessible without destroying the article of manufacture. An over-mold portion encapsulates at least a portion of the inner core portion, the over-mold portion also being formed by an over-mold injection molding process.

In yet another aspect, the present invention is directed to a method for making a gaming chip. The method includes providing an RFID inlay device including a programmable integrated circuit coupled to a propagation element disposed on a first side of a rigid two-sided printed circuit board. A protective material is disposed over the programmable integrated circuit on the first side. The protective material has at least one material characteristic protecting the programmable integrated circuit from a predetermined applied pressure and a predetermined ambient temperature. The RFID inlay is covered by the protective material in a first injection mold. A first plastic material is injected into the first injection mold to encapsulate the RFID inlay and the protective material within a first article of manufacture. The plastic material is injected at a molding pressure that is lower than the predetermined applied pressure and at a molding temperature lower than the predetermined ambient pressure, whereby the RFID inlay is not accessible without destroying the article of manufacture.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a side view of an RFID inlay in accordance with the present invention;

FIG. 2 is a side view of the RFID inlay depicted in FIG. 1 with a protective material disposed thereon;

FIG. 3 is a detail view of the printed circuit board depicted in FIG. 1;

FIG. 4 is a plan view of the RFID inlay depicted in FIG. 1;

FIG. 5 is a top view of a partially formed gaming chip after an initial injection molding step;

FIG. 6 is a top view of a secure gaming chip in accordance with an embodiment of the present invention;

FIG. 7 is a cross-sectional view of the gaming chip depicted in FIG. 6:

FIG. 8 is a detail view of an RFID inlay in accordance with an alternate embodiment of the present invention; and

FIG. 9 is a plan view of the RFID inlay depicted in FIG. 8.

### DETAILED DESCRIPTION

Reference will now be made in detail to the present exemplary embodiments of the invention, an examples of which are illustrated in the accompanying drawings. Wherever possible, the same reference numbers will be used throughout the drawings to refer to the same or like parts. An example embodiment of the secure gaming chip of the present invention is shown in FIG. 6, and is designated generally throughout by reference numeral 10.

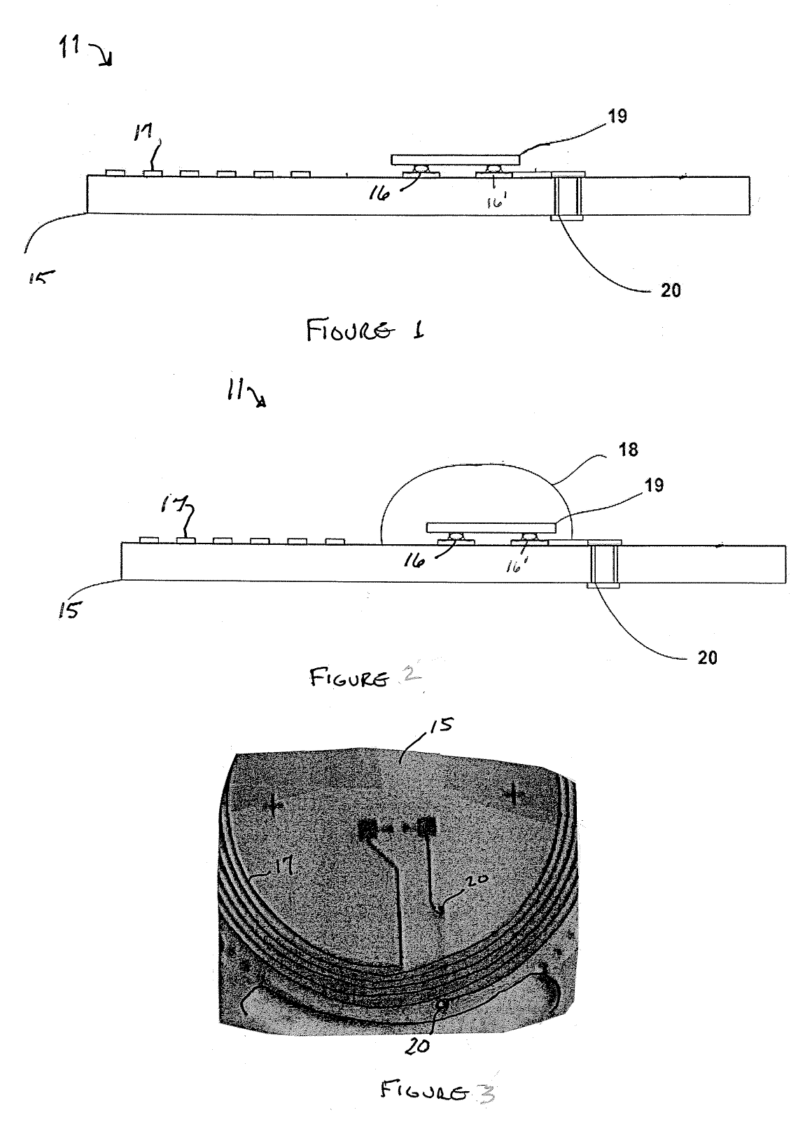

As embodied herein, and depicted in FIG. 1, a side view of an RFID inlay 11 in accordance with the present invention is disclosed. Inlay 11 includes RFID die 19 disposed on a rigid printed circuit board (PCB) 15. An inductive coupler element 17 may be formed on the surface of PCB 15 by printing, etching or any other suitable means. The inductive coupler 17 is subsequently connected to die 19 by way of contacts 16, 16′ to complete the circuit. The inductive coupler 17 is connected to contact 16′ by way of through holes 20. The integrated circuit die 19 is programmed to include chip identification data. Because it is programmable, the contents of the memory may be changed and updated in accordance with instructions received from a reader device. Of course, the reader device, in this embodiment, transmits the instructions via near-field magnetic coupling. The width, thickness, spacing and geometry of inductive coupling element 17 are selected to ensure that the chip response, when in close proximity to other chips or is disposed in a stack of chips, is close to the center frequency of 13.56 MHz. With regard to the resonant frequency, inlay 11 or die 19 may include an internal capacitive element for tuning purposes. This ensures that read/write operations are performed accurately and consistently.

Referring to FIG. 2, a protective coating 18 is disposed over die 19 in a subsequent process step. Coating 18 is formulated and disposed over die 19 in order to shield the die from the environmental stresses produced by the molding process. As noted above, the plastic injection molding temperature is approximately 300° C. On the other hand, the solder reflow temperature employed in flip-chip bonding is about 240° C. The molding temperature is above the solder melting temperature. Furthermore, the molding process may apply approximately 13.8 N/mm² to an unprotected die. Semiconductor dies may crack if the applied pressure exceeds 4 N/mm². Therefore, unless the die 19 is adequately protected from the thermal and mechanical stresses of the injection molding process, the inlay 11 may be expected to fail. Accordingly, protective coating 18 is essential to the survivability and integrity of the die 19 during the molding process.

It will be apparent to those of ordinary skill in the pertinent art that modifications and variations can be made to protective coating 18 of the present invention depending on its response to the environmental stresses, such as temperature, shearing forces, and pressure, produced by the injection molding process. For example, protective coating 18 may be implemented using either heat curable or UV curable compositions having a Shore D hardness value of at least 80, a linear shrinkage of less than 0.5%, and a glass transition temperature (T_{g}) of greater than 130° C. If the protective coating 18 is too soft and the glass transition temperature (T_{g}) too low, the molding material will press upon the die and cause damage. The protective coating is also configured to adhere to both die 19 and the epoxy glass PCB 15 at 300° C. With regard to the thickness of the coating 18, the over-all thickness of coating 18, die 19, and PCB 15 is approximately 50 mils. The protective coating 18 is also selected to be “compatible” with the plastic/polymer molding material in the sense that coating 18 is not absorbed into the plastic during the molding process. For example, an X-ray of gaming chip 10 (See FIG. 6) will reveal an intact protective coating 18.

In one embodiment, protective coating 18 may be implemented using Dexter Hysol EO1072. As those of ordinary skill in the art will appreciate, any suitable protective coatings such as Poly vinyl butyral, nitro-cellulose, paiylene, and UV cured epoxies having appropriate material characteristics. For example, a suitable protective coating may be characterized by glass transition temperature (T_{g}) that is 150° C. or higher, a Shore D hardness value greater than or equal to 80, and a linear shrinkage of less than approximately 0.5%. Protective coating 18 may also be implemented using AMICON 50300LT, a material manufactured by Emerson & Cummings. In other embodiments, high temperature formulations having a glass transition temperature (T_{g}) of approximately 260° C. may be employed.

Coating 18 is typically applied by a syringe to ensure that coating 18 is thick enough to shield inlay 11 from the thermal and mechanical stresses described above. On the other hand, processes such as dipping, spraying, or vacuum deposition typically apply a relatively thin coat cannot withstand the rigors of the injection molding process.

In one embodiment of the present invention, RFID inlay 11 includes an ISO 15693 compliant integrated circuit device. The operating frequency of the device is in the HF RFID band at 13.56 MHz and employs inductive coupling to communicate with a reader device. The approximate maximum read distance is in an approximate range between three and five feet. Die 19 includes a read/write memory of at least 500 bits. In one embodiment, the memory is about 2 K bits. According to the ISO/IEC 15693-2 standard, bi-directional communications may be effected between the RFID device 11 and a reader device using ASK modulation. The RFID inlay 11 may also employ FSK modulation in communicating with the reader.

In another embodiment of the present invention, RFID inlay 11 may be implemented as an electric field mode propagation systems operating in an approximate range between 400 MHz and 960 MHz. Of course, those of ordinary skill in the art will understand that this frequency range actually includes several frequency bands (i.e., 433 MHz; 902-928 MHz; 860-868 MHz; and 950-960 MHz). Those of ordinary skill in the art will understand that, in the electric field RF propagation element, the inductive coupler 17 is replaced by a short dipole antenna configured to transmit and receive radio waves. The frequency range for a UHF device is in a range between 860 MHz and 930 MHz. UHF inlays 11 may be implemented as either an electric field RF propagation element or a magnetic H-field propagation element. The H-field element is implemented as a small one-turn loop configured to support near field coupling. For example, UHF inlay 11 may be implemented as an ISO/IEC 18000-6 compliant device.

In any event, the RFID device of the present invention is configured to employ one-time password encryption techniques to mitigate any security risks posed by hackers and the like. The die is programmed to include a unique manufacturer identification code (UID). Further, the device is programmed at the casino or gaming establishment such that a 160 bit password is written into the die memory. The password may be used only once.

Each password is uniquely generated by a secure algorithm disposed in the network server. If the secure gaming chip 10 is stolen and the password is read and copied by a hacker, the password would be accepted only once. As such, the present invention limits any losses due to theft. On the other hand, if a transaction between a player and a dealer were read by a sniffer device, the captured data would be useless to the counterfeiter because the password was used during the player/dealer transaction. While the die memory may include a sequence of data written into the die memory, the data cannot be used to generate valid passwords because the secure generating algorithm is a one-way function.

In one embodiment, the password is generated by an encryption algorithm such as RSA. RSA typically employs a public key and private key. Those of ordinary skill in the art will understand that a key is a constant subsequently used in the encryption algorithm. The public key may be used during encryption. The private key is used to decrypt the password. Thus, only the holder (i.e. the casino management system) of the private key may validate the one-time password. Reference is made to U.S. Pat. No. 4,405,829, which is incorporated herein by reference as though fully set forth in its entirety, for a more detailed explanation of a secure algorithm for generating a secure one-time password.

Reference is made to PCT Patent Application No. CA 2005/001519, Published PCT Patent Application WO/2005/125078, and PCT Patent Application No. CA 2005/001338, System and Method for permitting Identification and Counting of Gaming Chips, which are incorporated herein by reference as though fully set forth in their entirety, for a more detailed explanation of the data security features employed by the present invention.

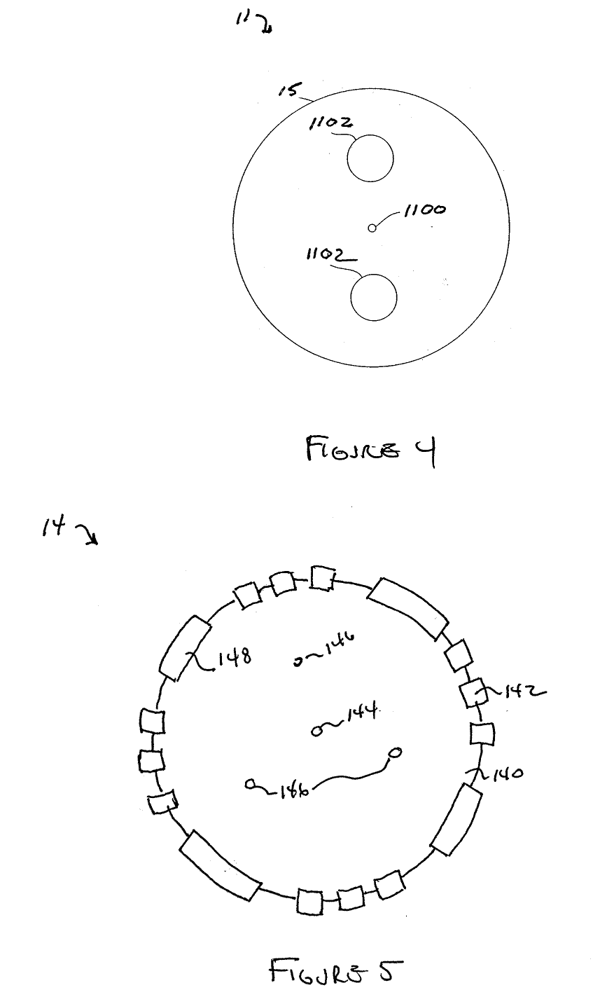

Referring to FIG. 3, a detail view of the printed circuit board 15 and through hole 20 is disclosed. PCB 15 is a double sided board that employs plated through holes 20 that are configured to facilitate the coupler/die connection. As shown, the through-hole arrangement eliminates the use of the relatively unreliable cross-over used in single-sided PCB coupler circuits. Note also that the inductive coupler 17 may be disposed in a spiral pattern on PCB 15.

PCB 15 may be comprised of any rigid material configured to withstand the environmental rigors of injection molding processes. Those of ordinary skill in the art will understand that the temperature of melted plastic materials employed in an injection molding process may exceed 300° C. In one embodiment, PCB may be implemented using a copper clad laminate material such as an epoxy glass FR4 circuit board having a thickness of approximately 22 mils. While PCB 15 may soften during the first phase of the injection molding process, it will not liquefy or vaporize like the flexible substrates employed in conventional designs. On the other hand, conventional RFID inlays are fabricated using flexible materials, such as polyester films, will melt, deform, or even vaporize during the injection molding process.

Another issue related to the injection molding process relates to the PCB/die connection. Convention RFID devices typically employ a conductive glue in implementing contacts 16, 16′. Such conductive glues will not survive the molding process. Accordingly, die 19 may be flip-chip soldered to PCB 15 or wire-bonded to PCB 15. However, those of ordinary skill in the art will understand that any method of connecting die 19 to PCB 15 may be employed that is suitable for use in injection molding processes.

Referring to FIG. 4, a plan view of RFID inlay 11 is disclosed. RFID 11 is configured to include injection molding tooling hole 1100 and material flow holes 1102. Material flow holes perform at least two functions. First, they ensure that the molten plastic employed in the injection molding process completely encapsulates inlay 11. The flow holes 1102 also perform a physical security function by making the inlay 11 very difficult to remove once the molded core portion of the gaming chip has cooled. Injection molding tooling hole 1100 is employed to position and align RFID 11 within the molding apparatus (not shown). Of course, those of ordinary skill in the art will understand that other positioning devices may be employed to align and position RFID 11 within the mold. RFID positioning devices may include, but are not limited to, projections, indentations, or combinations thereof.

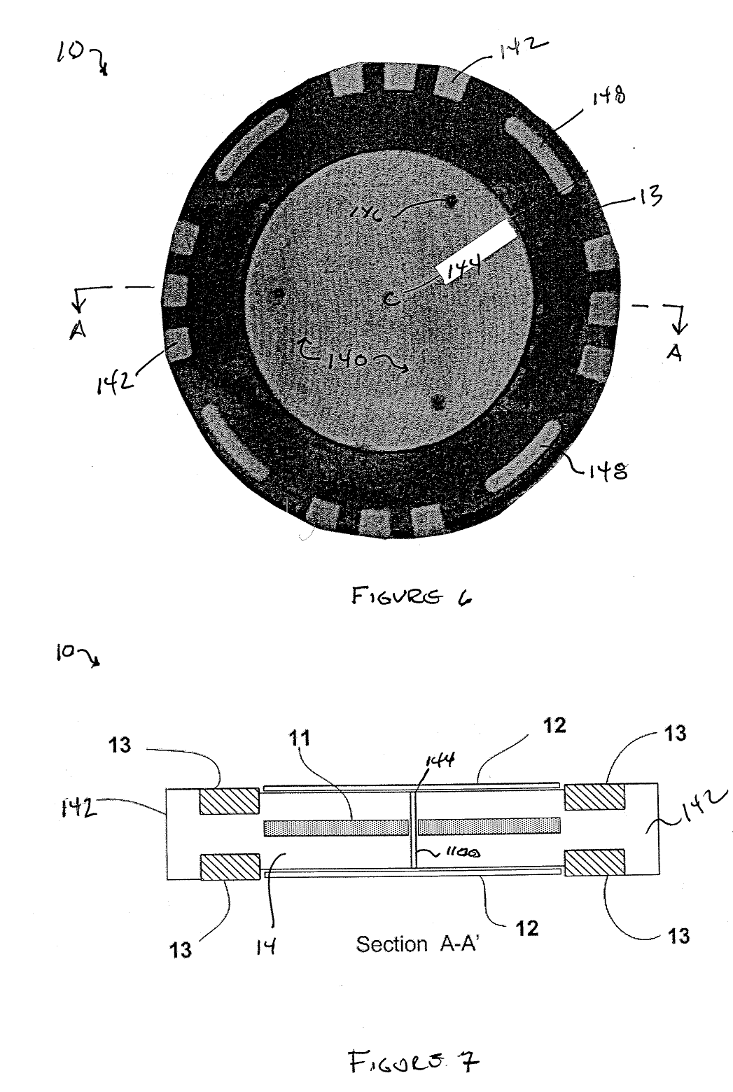

The injection molding apparatus may include a bottom half-mold portion that has a cavity shaped to conform to the inner core portion 14 of the gaming chip (See FIG. 5). The cavity is connected to fluid flow channels in a manner known in the art. The molding apparatus includes a center post that extends through tooling hole 1100. A plurality of support posts that extend from the bottom of the molding cavity and are employed to provide RFID inlay 11 with appropriate support. These posts are spaced evenly about the center post. Of course, the molding apparatus includes a top half-mold portion configured to mate and align with the bottom half-mold portion. The top half-mold portion also includes support posts. When the top half-mold portion is pressed against the bottom half-mold portion, RFID 11 is held securely in place within the molding apparatus to prevent any vertical movement during the molding process. The insertion of the center post within tooling hole 1100 prevents lateral movement during the molding process.

As those of ordinary skill in the injection molding arts will appreciate, once the top and bottom mold portions are securely in place, with the RFID inlay 11 inside, a polymer material is injected into the mold. The polymer material flows into the cavity encapsulating the RFID inlay 11. After the injection molding process the resultant piece is cooled and removed from the mold 50.

As embodied herein and depicted in FIG. 5, a top view of the inner core portion 14 of the secure gaming chip is disclosed. Inner core portion 14 includes a circular interior portion having exterior teeth 142 and exterior edge portions 148 disposed around the periphery. The circular interior portion includes a central hole 144 that corresponds to tooling hole 1100 and the center post of the molding apparatus. The circular interior portion also includes holes 146 corresponding to the mold support posts. Teeth 142 and edge portions 148 are raised relative to circular interior portion 140 for reasons that will become readily apparent.

After cooling, inner core member 14 is disposed in a second injection molding apparatus and a second polymer material is injected. The second polymer is typically of a different color than the inner core 14. The second molding step is employed to fill in the gaps between teeth 142 and edge portions 148 with an over-mold layer 13.

Referring to FIG. 6, a top view of a finished secure gaming chip in accordance with an embodiment of the present invention is disclosed. After gaming chip 10 is removed from the second mold, it is machined in a manner commonly known in the art. The machining step is used to clean the outer edges and to shape the game chip 20 to a standard diameter of 39 millimeters. Accordingly, the surface of chip 10 at the interface of over-mold portion 13 and the exposed inner core portions, i.e., teeth 142 and edge portions 148, is substantially uniform.

Those of ordinary skill in the art will understand that the shape of the gaming chip may of any suitable configuration such as circular, oval, hexagonal, octagonal, square, or rectangular, to name a few. The RFID gaming chip of the present invention may be manufactured to have a diameter or lateral surface dimension of approximately 25 millimeters. Of course, the gaming chip can be larger and have a diameter of approximately 39 millimeters (a typical international dimension) or have a diameter of approximately 43 millimeters, which is typically employed in U.S. casinos. Some rectangular plaques have dimensions as large as 105 millimeters.

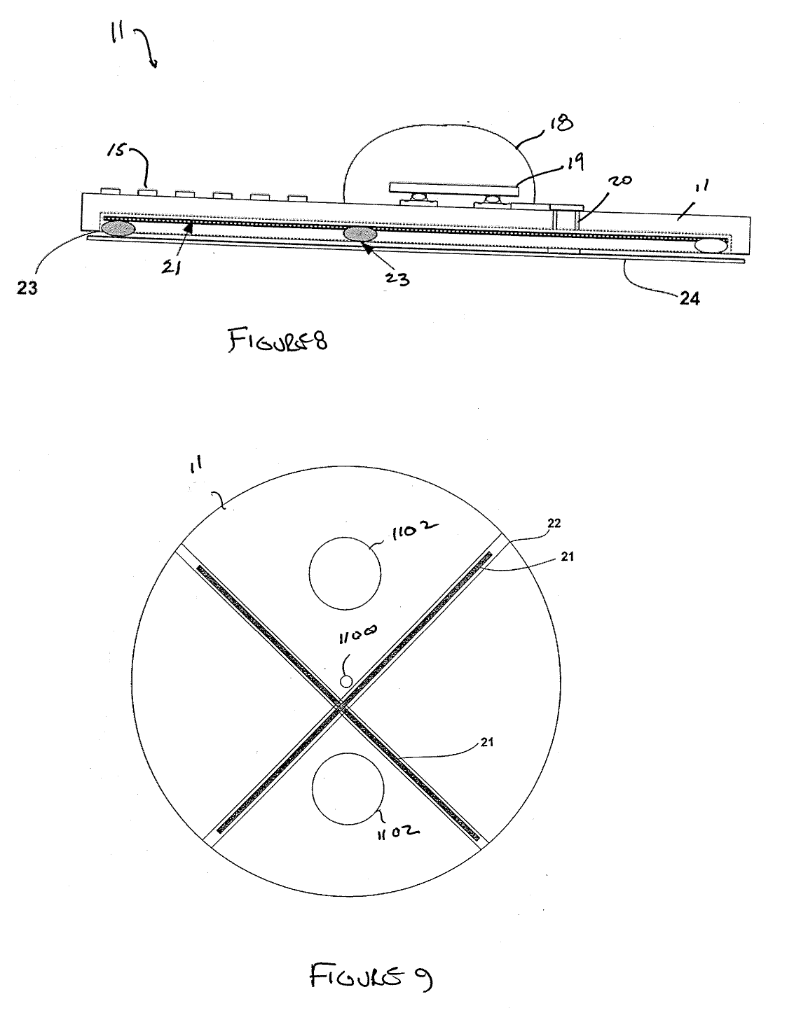

FIG. 7 is a cross-sectional view of the gaming chip shown in FIG. 6 taken through line A-A. As shown, RFID 11 is encapsulated within inner core 14. The interior circular portion of inner core 14 is exposed and recessed relative to over-mold portion 13. The recessed portion may be employed to accommodate a printed inlay 12. Of course, if the printed inlay 12 is removed, no access to the RFID inlay 11 will be provided without destroying the RFID inlay.

As embodied herein and depicted in FIG. 8, a detail view of an RFID inlay in accordance with an alternate embodiment of the present invention is disclosed. This embodiment is a variation of the embodiment depicted in FIG. 1. As such, the discussion regarding PCB 15, die 19, and protective coating 18 provided above is equally applicable to this embodiment of the present invention. The embodiments shown in FIG. 8 and FIG. 9 differ from the embodiments previously disclosed by virtue of the magnetic marker disposed in the underside of PCB 15.

Referring to FIG. 9, a cross-shaped pattern 22 is disposed in PCB 15 by a milling process or by some other suitable means. Soft magnetic amorphous alloy ribbons 22 are disposed within channels 22. In one embodiment of the present invention, the ribbons 21 are substantially 28 mm in length and approximately 40 micro-inches in thickness. Ribbons 21 are retained in channels 22 by an adhesive 23. Subsequently, a conformal coat of solder mask is applied to the underside portion of PCB 15 to protect ribbons 21. Note that the two-crossed magnetic ribbons increases the probability that detection will be successful irrespective of the gaming chip orientation.

The magnetic marker formed by the ribbons 22 helps reduce chip theft. Casinos may employ reader devices configured to detect the markers at the establishment's exits. The magnetic marker also may be employed to authenticate the chip because it provides another redundant security feature difficult to copy. Along the same lines, it is noted that magnetic material response waveforms vary according to exact alloy composition. There are approximately fifty alloy variations that are possible. Thus, each batch of gaming chips could be further identified by a unique magnetic material response waveform to thereby provide a second independent form of authentication. In one embodiment, the ribbons are comprised of an amorphous ferromagnetic material such as NiFe or NiFeCo. In another embodiment, the material is Metglas alloy 2605-S3, which is approximately 80 Fe, 20 B, along with other trace elements. In other embodiments, the magnetic ribbons may have a magnetic coercivity in the range of 0.1 and 1.0 oersteds. The magnetic permeability may be in the range of 100,000 and 1,000,000. Ribbons 22 may have a magnetic saturation in the range between 0.5 and 2.0 Telsa. In any event, the ribbons 22 do not interfere with the electrical operation of the printed RFID inlay 11 and the RFID inlay does not adversely affect the operation of the magnetic marker 22.

In accordance with an embodiment of the present invention, magnetic marker 22 is formed from a strip of easily magnetizable material that is characterized by high magnetic permeability, low magnetic coercivity and low magnetic saturation. The magnetic marker 22 is configured to respond to the alternating magnetic interrogation fields generated by an electronic article surveillance system of the type described in U.S. Pat. No. 4,623,877. The marker 22 generates distinctive disturbances in the interrogation fields. When secure gaming chip 10 of the present invention passes through an interrogation zone, the gaming chip 10 produces characteristic disturbances in the alternating magnetic interrogation fields. The disturbances are detected by the surveillance system. Of course, the surveillance system includes an appropriate alarm display. For example, The surveillance system provide a visual or an audible alarm to signal the passage of the article through the interrogation zone. The received signals are a function of the shape of the B-H hysteresis curve which, as noted previously, may be altered by changing the alloy composition.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,”“including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An article of manufacture comprising:
an RFID inlay including a programmable integrated circuit coupled to a propagation element on a first side of a rigid two-sided printed circuit board, the programmable integrated circuit being covered by a protective material having at least one material characteristic, whereby the programmable integrated circuit is hardened to withstand a predetermined applied pressure and a predetermined ambient temperature; and
at least one molded exterior portion encapsulating the RFID inlay, the at least one molded exterior portion being formed by an injection molding process characterized by a molding pressure that is lower than the predetermined applied pressure and a molding temperature lower than the predetermined ambient pressure, whereby the RFID inlay is not accessible without destroying the article of manufacture.

2. The article of claim 1, wherein the article is a gaming chip having a diameter of approximately 39 millimeters.

3. The article of claim 2, wherein the at least one molded exterior portion further comprises an over-mold portion encapsulating at least a portion of an injection molded inner core portion.

4. The article of claim 1, wherein the propagation element is a near-field inductive coupler configured to communicate with a reader via a magnetic flux.

5. The article of claim 4, wherein the near-field inductive coupler is characterized by at least one geometric parameter.

6. The article of claim 5, wherein the at least one geometric parameter includes a coupler trace width, a coupler trace spacing, a coupler trace thickness, and/or an inductive coupler geometric pattern.

7. The article of claim 5, wherein the near-field inductive coupler is an LC circuit characterized by a resonant frequency.

8. The article of claim 5, wherein the RFID inlay operates in accordance with 13.56 MHz RFID frequencies.

9. The article of claim 1, wherein the molding temperature is approximately 300° C.

10. The article of claim 1, wherein the molding pressure is approximately 14 N/mm².

11. The article of claim 1, wherein the at least one material characteristic includes a Shore D hardness value greater than or equal to 80.

12. The article of claim 1, wherein the at least one material characteristic includes a linear shrinkage of less than 0.5%.

13. The article of claim 1, wherein the at least one material characteristic includes a glass transition temperature greater than 130° C.

14. The article of claim 1, wherein the at least one material characteristic includes a thickness less than 50 mils.

15. The article of claim 1, wherein the propagation element is a radio antenna operating in a predetermined frequency band within an approximate range between 400 MHz and 960 MHz.

16. A secure gaming chip comprising:
an RFID inlay including a programmable integrated circuit coupled to a propagation element on a first side of a rigid two-sided printed circuit board, the programmable integrated circuit being programmed to include a one-time password, the programmable integrated circuit being covered by a protective material having at least one material characteristic, whereby the programmable integrated circuit is hardened to withstand a predetermined applied pressure and a predetermined ambient temperature;
at least one molded exterior portion encapsulating the RFID inlay, the at least one molded exterior portion being formed by an injection molding process characterized by a molding pressure that is lower than the predetermined applied pressure and a molding temperature lower than the predetermined ambient pressure, whereby the RFID inlay is not accessible without destroying the gaming chip.

17. The chip of claim 16, wherein the at least one molded exterior portion further comprises an over-mold portion encapsulating at least a portion of an injection molded inner core portion.

18. The chip of claim 17, wherein the chip has a diameter of approximately 39 millimeters.

19. The chip of claim 16, wherein the programmable integrated circuit is programmed with a time stamped one-time password.

20. The chip of claim 19, wherein the one-time password is a 160 bit digital word generated by a one-way encryption algorithm.

21. The chip of claim 16, further comprising a magnetic marker disposed on a second side of the printed circuit board.

22. The chip of claim 21, wherein the magnetic marker is characterized by a unique predetermined magnetic material response waveform configured to respond to alternating magnetic interrogation fields generated by an electronic article surveillance system.

23. The chip of claim 16, wherein the propagation element is a near-field inductive coupler configured to communicate with a reader via a magnetic flux.

24. The chip of claim 23, wherein the near-field inductive coupler is characterized by a coupler trace width, a coupler trace spacing, a coupler trace thickness, and/or an inductive coupler geometric pattern based a on predetermined resonant frequency.

25. The chip of claim 23, wherein the near-field inductive coupler is an LC circuit characterized by a resonant frequency.

26. The chip of claim 16, wherein the RFID inlay operates at a carrier frequency of 13.56 MHz.

27. The chip of claim 16, wherein the molding temperature is approximately 300° C.

28. The chip of claim 16, wherein the molding pressure is approximately 14 N/mm².

29. The chip of claim 16, wherein the at least one material characteristic includes a Shore D hardness value greater than or equal to 80.

30. The chip of claim 16, wherein the at least one material characteristic includes a linear shrinkage of less than 0.5%.

31. The chip of claim 16, wherein the at least one material characteristic includes a glass transition temperature greater than 130° C.

32. The chip of claim 16, wherein the protective material has an approximate thickness that is less than 30 mils.

33. The chip of claim 32, wherein the protective material has an approximate diameter that is less than 300 mils.

34. The chip of claim 16, wherein the propagation element is a radio antenna operating in an approximate range between 400 MHz and 915 MHz.

35. A secure gaming chip comprising:
an RFID inlay including a programmable integrated circuit coupled to a propagation element on a first side of a rigid two-sided printed circuit board, the programmable integrated circuit being programmed to include a one-time password, the RFID inlay device also including a magnetic marker disposed on a second side of the printed circuit board, the magnetic marker being characterized by a unique predetermined magnetic material response waveform, the programmable integrated circuit being covered by a protective material having at least one material characteristic, whereby the programmable integrated circuit is hardened to withstand a predetermined applied pressure and a predetermined ambient temperature; and
an inner core portion encapsulating the RFID inlay and the protective material, the inner core portion being formed by an injection molding process characterized by a molding pressure that is lower than the predetermined applied pressure and a molding temperature lower than the predetermined ambient pressure, whereby the RFID inlay is not accessible without destroying the article of manufacture; and
an over-mold portion encapsulating at least a portion of the inner core portion, the over-mold portion being formed by an over-mold injection molding process.

36. A method for making a gaming chip comprising:
providing an RFID inlay device including a programmable integrated circuit coupled to a propagation element disposed on a first side of a rigid two-sided printed circuit board;
disposing a protective material over the programmable integrated circuit on the first side, the protective material having at least one material characteristic protecting the programmable integrated circuit from a predetermined applied pressure and a predetermined ambient temperature;
disposing the RFID inlay covered by the protective material in a first injection mold; and
injecting a first plastic material into the first injection mold to encapsulate the RFID inlay and the protective material within a first article of manufacture, the plastic material being injected at a molding pressure that is lower than the predetermined applied pressure and at a molding temperature lower than the predetermined ambient pressure, whereby the RFID inlay is not accessible without destroying the article of manufacture.

37. The method of claim 36, further comprising:
disposing the first article of manufacture in a second injection mold;
injecting a second plastic material into the second injection mold to at least partially encapsulate the first article of manufacture within an outer portion; and
machining the outer portion and any exposed portions of the first article of manufacture to form a gaming chip.

38. The method of claim 37, wherein the gaming chip has a diameter of approximately 39 millimeters.

39. The method of claim 37, wherein the gaming chip has a diameter of approximately 43 millimeters.

40. The method of claim 37, wherein a shape of the gaming chip is selected from a group of shapes that include a circular shape, an oval shape, a hexagonal shape, a octagonal shape, a square shape, or a rectangular shape.

41. The method of claim 37, wherein the gaming chip has a major surface dimension within a range between 25-110 millimeters.

42. The method of claim 36, further comprising:
generating a one-time password using a one-way encryption algorithm;
writing the one-time password into a read/write memory disposed in the programmable integrated circuit.

43. The method of claim 36, wherein the read/write memory includes at least 500 bits of storage.

44. The method of claim 43, wherein the read/write memory includes approximately 2 Kbits of storage.

45. The method of claim 36, wherein the step of providing further comprises the step of disposing a magnetic marker on a second side of the printed circuit board, the magnetic marker being characterized by a unique predetermined magnetic material response waveform configured to respond to alternating magnetic interrogation fields generated by an electronic article surveillance system.

46. The method of claim 45, wherein the magnetic marker includes at least one magnetic ribbon.

47. The method of claim 46, further comprising:
machining a cross-shaped pattern in a surface of the first article of manufacture, the cross-shaped pattern including a first channel intersected by a second channel;
disposing a first magnetic ribbon in the first channel; and
disposing a second magnetic ribbon in the second channel.

48. The method of claim 36, wherein the step of providing includes flip-chip bonding the programmable integrated circuit to the propagation element disposed on the first side of the rigid two-sided printed circuit board.

49. The method of claim 36, wherein the step of providing includes wire bonding the programmable integrated circuit to the propagation element disposed on the first side of the rigid two-sided printed circuit board.
